(19) United States
(12) Patent Application Publication
(10) Pub. No.: US 2002/0124348 A1
(43) Pub. Date: Sep. 12, 2002

(54) Multi-purpose element for sliding metal racks located inside furniture

(76) Inventor: Rossano Compagnucci, Osimo (IT)

Correspondence Address: Leonard Bloom & Associates, Suite 220, 502 Washington Avenue, Towson, MD, 21204, US

(21) Appl. No.: 10/048,143

(22) PCT Filed: Jun. 4, 2001
(86) PCT No.: PCT/IT01/00284

(30) Foreign Application Priority Data
Jun. 6, 2000 (IT) MC-2000A000049

(51) Int. Cl. E05D 15/00

(52) U.S. Cl. 16/94 R

(57) ABSTRACT

The present invention relates to a multi-purpose element for sliding metal racks located inside furniture, consisting in a box-type bar with upturned-U cross section that acts both as bearing structure for the body of the rack and as protection cover for the telescopic guides of the rack.

The present patent application for industrial invention relates to an element for sliding racks made of metal wire and located inside furniture, in particular modular kitchen cabinets.

As it is known, kitchen cabinets are commonly equipped with removable internal racks, whose bottom consists in a grid obtained by soldering multiple rod irons, while the bearing structure is usually made up of a frame obtained with metal profiles or pressed metal plates suitably shaped to act as slide guides.

More precisely, the bearing frame of the racks lays and slides on two lateral pairs of wheels that in turn slide inside a rail located in a fixed counter-guide, tightened on the inside of the two opposite sides of the cabinet.

Special telescopic guides are normally used to provide for better extraction of the rack from its housing. The guides are inserted one into each other, with the external guide tightened to the cabinet wall and the internal guide to the bearing frame of the rack.

This type of telescopic guides ensures balanced, smooth and noiseless sliding of the rack, compared to the system using two sliding wheels between a mobile guide (that coincides with the rack frame) and a fixed counter-guide.

However, a disadvantage of this type of telescopic guides is represented by their unpleasant aspect when the rack has been completely extracted.

An additional inconvenience of practical nature is represented by the fact that the use of these telescopic guides requires the presence of suitable means to fix the guides to the rack frame.

The main purpose of the present invention is to provide a solution to both inconveniences, through the realisation of an element capable of acting as cover for the telescopic guides and at the same time as connection element between guides and rack.

More precisely, the cover for telescopic guides is also used as bearing element in the rack structure, being an integral part of it.

The cover can also be used to connect the rack to a front panel in order to realise a drawer, with a metal wire rack in its internal compartment.

To that end the cover has been provided with suitable seats and holes that can be used to fit and fix a special bracket, capable of being tightened on the internal face of the front panel.

The bracket is supplied as accessory with the cover.

Any type of frame, side or upright can be fixed above the cover to realise high racks or racks with multiple shelves.

The multi-purpose element for sliding metal racks according to the present invention consists in a box-type bar with upturned-U cross section that can exactly house and hide a telescopic guide.

The box-type bar is mounted on both sides of a metal rack, becoming an integral part of the rack structure.

The rear end of the box-type bar is open in order to act as entrance for the telescopic guide, whose external rod is fixed and tightened on the cabinet side.

Once the guide has been inserted into the open rear end of the bar, the rack can be pushed forward to completely insert the guide into the bar. The bar is provided with a coupling latch in order to automatically stop the guide inside the bar at the end of its forward travel, thus preventing the box-type bar from exiting the telescopic guide when the rack has been completely extracted.

As mentioned above, the front end of the bar, on the upper wall, features a seat for a special bracket that can be screwed into the internal face of a front panel.

For major clarity the description of the multi-purpose element for sliding metal racks according to the present invention continues with reference to the enclosed drawings, which are intended for purposes of illustration and not in a limiting sense, whereby:

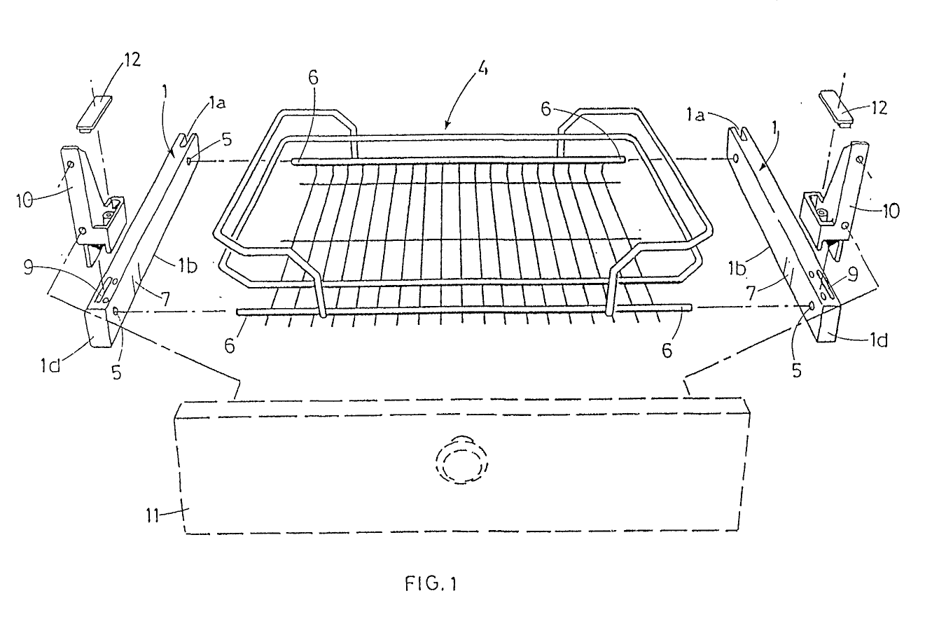

FIG. 1 is an exploded perspective of a metal rack with two box-type bars with upturned-U cross section mounted on the sides;

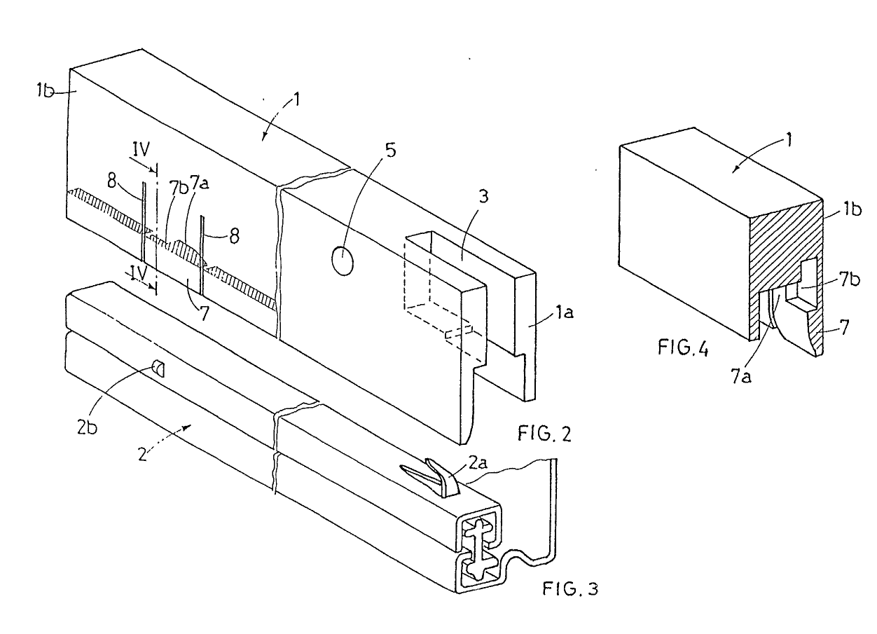

FIG. 2 is an axonometric view of one box-type bar with upturned-U cross sections seen from the back, that is from the opening for the telescopic guide;

FIG. 3 is an axonometric view of an ordinary telescopic guide to be inserted and hidden inside each box-type bar with upturned-U cross section;

FIG. 4 is a section of the box-type bar with plane IV-IV of FIG. 3.

With particular reference to FIGS. 2 and 4, the multi-purpose element for sliding metal racks according to the present invention consists in a box-type bar (1) with upturned-U cross section that can exactly house and hide a telescopic guide (2) of known type.

The rear end (1a) of the box-type bar (1) is open in order to act as entrance for the telescopic guide (2), which is provided with a hook (2a) capable of fitting into the niche (3) suitably located in the rear end of the bar (1), as shown in FIG. 2.

Once the guide (2) has been completely inserted into the bar (1), the hook (2a) automatically hooks the bar (1) that can no longer be detached from the guide (2) fixed inside the two sides of the cabinet by simply lifting it upwards.

The box-type bar (1) is mounted on both sides of a metal rack (4), becoming an integral part of the structure of the rack (4).

The coupling of the bars (1) to the guides (2) through the hook (2a) eliminates any risk of overturning the rack at the end of the extraction travel.

In the preferred embodiment of the invention, a lateral side (1b) of the bar (1) has some holes (5) (only two in this specific case), in which the ends of an equivalent number of rod irons (6) are forced, becoming an integral part of the rack (4).

This means that the metal rack manufacturer will provide the furniture maker in charge of installing the metal racks in the cabinets with a metal rack (4) already provided with two lateral bearing bars (1).

The furniture maker will only need to fix the telescopic guides (2) inside the two sides of the cabinet.

The installation of the rack (4) inside the cabinet is very simple.

Once the guide (2) has been inserted into the open rear end (1a) of the bar (1), the rack (4) can be pushed forward to completely insert the two guides (2) into the two bars (1). Each bar (1) is provided with a coupling latch in order to automatically stop the guide (2) inside the bar (1) at the end of its forward travel:

The coupling latch-prevents the rack (4) from exiting from the guides (2).

With particular reference to FIGS. 3 and 4, it must be noted that the coupling latch is made up of an elastically flexible tongue (7) located on a wall of the bar (1) provided with two notches (8) capable of isolating the intermediate tongue (7).

The internal face of the tongue (7) has a section (7a) with higher thickness provided with a seat (7b) that can house the tooth (2b) located on the internal wall of the guide (2).

When the guide (2) is inserted inside the bar (1), the tooth (2b) interferes with the section (7a) causing the elastic outward flexion of the tongue (7), that snaps back into its idle position as soon as the tooth (2b) passes over the section (7a) and fits into the seat (7b).

On its front end (1d), on the upper wall, the bar (1) is provided with a seat (9) in which a special bracket (10) can be fitted and tightened on the internal face of a front panel (11) to obtain a drawer with a metal rack in its internal compartment.

If the bracket (10) is not mounted on the bar (1), the slot (9) can be covered with a lid (12) forced inside the slot (9).

The description above clearly shows the multi-purpose function of the bar (1) that can act as:

bearing structure for the body of the metal rack (4);

protection cover for the telescopic guides (2);

support element for brackets (10) used to connect the rack (4) to the front panel (11) of a drawer;

support element for frames, sides or edges used to realise high racks or racks with multiple shelves.

1) Multi-purpose element for sliding metal racks located inside furniture, characterised by the fact that it consists in a box-type bar (1) with upturned-U cross section capable of exactly housing and hiding a telescopic guide (2) of known type, and capable of being fixed to the two sides of a metal rack (4), becoming an integral part of it, acting as bearing structure of the body of the metal rack (4).

2) Multi-purpose element for sliding metal racks according to the previous claim, characterised by the fact that a lateral side (1b) of the bar (1) has some holes (5) in which the ends of an equivalent number of rod irons (6) are forced, becoming an integral part of the body of the metal rack (4).

3) Multi-purpose element for sliding metal racks according to claim 1), characterised by the fact that the bar (1) is provided with suitable means in order to prevent it from overturning and exiting from the guide (2), which is in turn provided with suitable co-operating means.

4) Multi-purpose element for sliding metal racks according to claim 3), characterised by the fact that the anti-overturning means consist in a notch (3) located on the rear end (1a) of the bar (1), which is open in order to act as entrance for the telescopic guide (2), which features a hook (2a) capable of fitting into the notch (3).

5) Multi-purpose element for sliding metal racks according to claim 3), characterised by the fact that the anti-loosening means consists in an elastically flexible tongue (7) located on a wall of the bar (1) provided with two notches (8) capable of isolating the intermediate tongue (7), whose internal face has a section (7a) with higher thickness provided with a seat (7b) that can house the tooth (2b) located on the internal wall of the guide (2).

6) Multi-purpose element for sliding metal racks according to the previous claims, characterised by the fact that on its front end (1d) on the upper wall, the bar (1) is provided with a seat (9) in which a special bracket (10) can be fitted and tightened on the internal face of a front panel (11) to obtain a drawer with a metal rack as internal compartment.
